(19) United States
(12) Patent Application Publication
(10) Pub. No.: US 2025/0360975 A1
(43) Pub. Date: Nov. 27, 2025

(54) REAR SUSPENSION STOP

(71) Applicant: Arctic Cat Inc., Thief River Falls, MN (US)

(72) Inventor: Brett Nehring, Thief River Falls, MN (US)

(73) Assignee: Arctic Cat Inc., Thief River Falls, MN (US)

(21) Appl. No.: 19/215,164

(22) Filed: May 21, 2025

Related U.S. Application Data
(60) Provisional application No. 63/650,645, filed on May 22, 2024.

(51) Int. Cl. B62D 55/104; B62M 27/02

(52) U.S. Cl. CPC B62D 55/104; B62M 2027/026

(57) ABSTRACT

A snowmobile includes a frame and a tractive assembly pivotably coupled to the frame. The tractive assembly includes a first rail, a second rail, a first crossmember extending between the first rail and the second rail, an arm having a first end pivotably coupled to the frame and an opposing second end, and a stop assembly. The stop assembly includes a second crossmember coupled to the arm, a cam coupled to the second crossmember, a first bracket coupled to first ends of the first crossmember and the second crossmember, a second bracket coupled to opposing second ends of the first crossmember and the second crossmember, and one or more stops coupled to at least one of the first bracket or the second bracket, the one or more stops configured to engage a portion of the cam to selectively prevent rotation of the arm.

### CROSS-REFERENCE TO RELATED PATENT APPLICATION

This application claims the benefit of and priority to U.S. Provisional Patent Application No. 63/650,645, filed May 22, 2024, which is incorporated herein by reference in its entirety.

### BACKGROUND

The present application relates to a suspension stop of a vehicle. More specifically, the present application relates to rear suspension stop of a snowmobile.

### SUMMARY

One embodiment relates to a snowmobile. The snowmobile includes a frame and a tractive assembly pivotably coupled to the frame. The tractive assembly includes a first rail, a second rail, a first crossmember extending between the first rail and the second rail, an arm having a first end pivotably coupled to the frame and an opposing second end, and a stop assembly. The stop assembly includes a second crossmember coupled to the arm, a cam coupled to the second crossmember, a first bracket coupled to first ends of the first crossmember and the second crossmember, a second bracket coupled to opposing second ends of the first crossmember and the second crossmember, and one or more stops coupled to at least one of the first bracket or the second bracket, the one or more stops configured to engage a portion of the cam to selectively prevent rotation of the arm.

Another embodiment relates to a snowmobile including a frame and a tractive assembly pivotably coupled to the frame. The tractive assembly includes a first rail, a second rail, a first crossmember extending between the first rail and the second rail, a first arm, a second arm, a stop assembly, and a block stop. The first arm has a first end and an opposing second end. The first end is pivotably coupled to the frame. The second arm has a first end and an opposing second end. The first end of the second arm is pivotably coupled to the frame. The stop assembly includes a second crossmember coupled to the first arm and the second arm, a cam coupled to the second crossmember, a first bracket coupled to first ends of the first crossmember and the second crossmember, a second bracket coupled to opposing second ends of the first crossmember and the second crossmember, and one or more stops. The one or more stops are coupled to at least one of the first bracket or the second bracket. The one or more stops are configured to engage a portion of the cam to selectively prevent rotation of the first arm and the second arm. The block stop is configured to engage at least one of the first bracket or the second bracket to selectively prevent rotation of the first bracket and the second bracket. The block stop extends between the first rail and the second rail.

Still another embodiment relates to a snowmobile including a frame and a tractive assembly pivotably coupled to the frame. The tractive assembly includes a first rail, a second rail, a first crossmember extending between the first rail and the second rail, an arm, a stop assembly, and a block stop. The first arm has a first end and an opposing second end. The first end is pivotably coupled to the frame. A first angle is defined between the arm and the first rail. The stop assembly includes a second crossmember coupled to the arm, a cam coupled to the second crossmember, a first bracket coupled to first ends of the first crossmember and the second crossmember, a second bracket, and one or more stops. A second angle is defined between the arm and the first bracket. The second bracket is coupled to opposing second ends of the first crossmember and the second crossmember. The one or more stops are coupled to at least one of the first bracket or the second bracket. The one or more stops are configured to engage a portion of the cam to selectively prevent rotation of the arm. The second angle is limited by the one or more stops. The block stop is configured to engage at least one of the first bracket or the second bracket to selectively prevent rotation of the first bracket and the second bracket. The block stop extends between the first rail and the second rail. The first angle is limited by the block stop. A first distance from the first crossmember to a rearmost portion of the snowmobile is greater than a second distance from the block stop to the rearmost portion of the snowmobile. A third distance from a surface engaged by the tractive assembly to the first crossmember is less than a fourth distance from the surface engaged by the tractive assembly to the block stop.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle, according to an exemplary embodiment.

FIG. 2 is a schematic block diagram of the vehicle of FIG. 1, according to an exemplary embodiment.

FIG. 3 is a perspective view of a rear portion of the vehicle of FIG. 1 including a rear stop assembly, according to an exemplary embodiment.

FIG. 4 is a side view of the rear portion of FIG. 3, according to an exemplary embodiment.

FIG. 5 is another perspective view of the rear portion of FIG. 3, according to an exemplary embodiment.

FIG. 6 is a detailed view of the rear portion of FIG. 5, according to an exemplary embodiment.

FIG. 7 is a detailed view of the rear portion of FIG. 6, according to an exemplary embodiment.

FIG. 8 is another side view of the rear portion of the vehicle of FIG. 1, according to an exemplary embodiment.

FIG. 9 is a detailed view of the rear portion of FIG. 8, according to an exemplary embodiment.

FIG. 10 is a side view of a rear stop assembly of the vehicle of FIG. 1, according to another exemplary embodiment.

FIG. 11 is a perspective view of the rear stop assembly of FIG. 10, according to an exemplary embodiment.

FIG. 12 is another perspective view of the rear stop assembly of FIG. 10, according to an exemplary embodiment.

FIG. 13 is another perspective view of the rear stop assembly of FIG. 10, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a rear stop assembly for a snowmobile is configured to limit an amount of movement and, therefore, an angle between components of a vehicle and a rear tractive assembly thereof. By way of example, the rear stop assembly may be configured to limit movement to a maximum angle by limiting a first angle between a rear arm and a bracket. The rear stop assembly may also be configured to allow a second angle between the bracket and a rail to adjust according to terrain changes. A stop coupled to the bracket is configured to span a distance between a first flange and a second flange of the bracket, causing the stop to reinforce the brackets and act as a structural bracing member to reinforce the bracket. This stop also assists in minimizing the weight of the rear stop assembly. The snowmobile may be more desirable to consumers seeking to summit a hill as effectively as possible without tipping backwards.

### Overall Vehicle

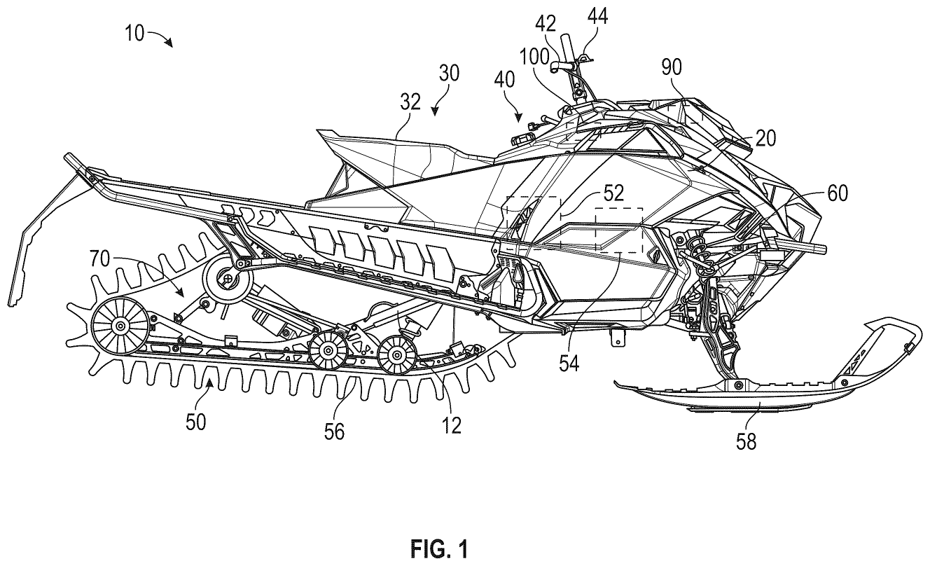

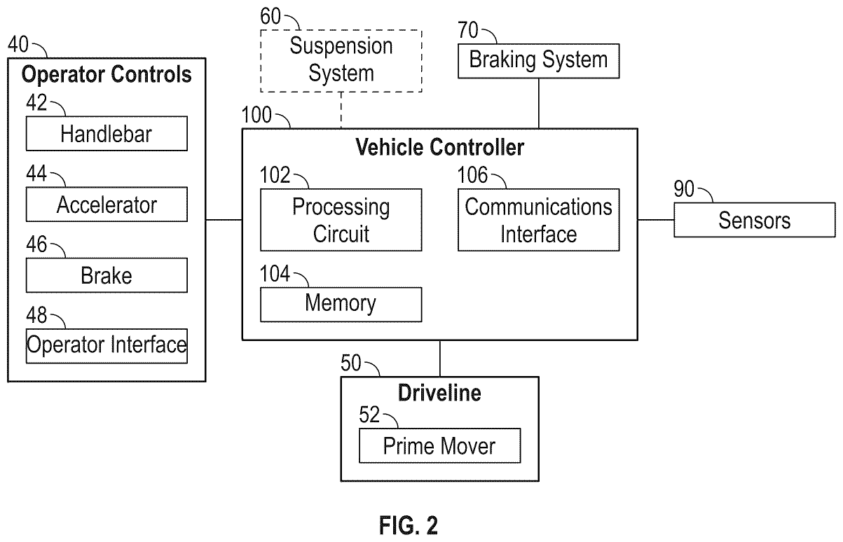

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is a tracked, winter-focused off-road machine or vehicle configured to be operated on a snowy and/or icy surface (e.g., operated in snow, on ice, etc.). In some embodiments, the tracked, winter-focused off-road machine or vehicle is a lightweight or recreational machine or vehicle such as a snowmobile, a snow bike, a snow scooter, a snow all-terrain vehicle (“ATV”), a snow utility task vehicle (“UTV”), a snow plow machine, and/or another type of lightweight or recreational machine configured to be operated on a snowy and/or icy surface. In other embodiments, the tracked, snow-focused off-road machine or vehicle is a large machine or vehicle such as a snowcat, a snow groomer, a snow plow machine, a tractor, and/or another type of large machine or vehicle configured to be operated on a snowy and/or icy surface. In still other embodiments, the vehicle 10 is a non-tracked, off-road machine or vehicle such as an ATV, a UTV, a dirt bike, and/or another type of non-tracked, off-road machine or vehicle.

According to the exemplary embodiment shown in FIG. 1, the occupant seating area 30 includes a first seat, shown as operator seat 32, configured to support an operator of the vehicle 10. In some embodiments, the occupant seating area 30 includes a double seat configured to support the operator of the vehicle 10 and a passenger of the vehicle 10 behind the operator, or a triple seat configured to support the operator of the vehicle 10 and two passengers of the vehicle 10 behind the operator. In some embodiments, the occupant seating area 30 includes a second seat positioned rearward of or to the side of the operator seat 32. The second seat may be configured to support passengers of the vehicle 10. In some embodiments, in addition to or in place of the second seat, the vehicle 10 includes one or more rear accessories. Such rear accessories may include a ski rack, a bed, a cargo body (e.g., for a storage, etc.), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a handlebar, a steering column, a handlebar assembly, joystick(s), a steering wheel, etc.), shown as handlebar 42, an accelerator interface (e.g., a pedal, a throttle, a throttle lever, etc.), shown as accelerator 44, a braking interface (e.g., a brake pedal, a brake lever, a brake arm, etc.), shown as brake 46, and one or more additional interfaces (e.g., a light control interface, an operational mode interface, etc.), shown as operator interfaces 48. The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., tracks, treads, axles, differentials, etc.), shown as rear tractive assembly 56, and a second tractive assembly (e.g., skis, runners, slides, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

According to the exemplary embodiment shown in FIG. 1, the rear tractive assembly 56 includes a rear tractive element that is configured as a track and the front tractive assembly 58 includes front tractive elements configured as skis. For example, the rear tractive element may be configured as a track configured to engage a snowy surface in order to drive the vehicle 10 and the front skis may be configured to slide or glide along the snowy surface. In some embodiments, the rear tractive assembly 56 includes a plurality of the rear tractive elements configured as tracks. In some embodiments, the front tractive assembly 58 includes front tractive elements that are configured as tracks. In other embodiments, the front tractive assembly 58 and the rear tractive assembly 56 include tractive elements that are configured as wheels.

According to an exemplary embodiment, the prime mover 52 is configured to provide power to drive the rear tractive assembly 56 (e.g., to provide rear-track drive, etc.). In some embodiments, the prime mover 52 is configured to provide power to drive the rear tractive assembly 56 and/or the front tractive assembly 58 (e.g., to provide front-track drive, to provide all-track drive, etc.). In some embodiments, the driveline 50 includes a transmission device (e.g., a gearbox, a continuous variable transmission (“CVT”), etc.) positioned between (a) the prime mover 52 and (b) the rear tractive assembly 56. In a non-track arrangement, the rear tractive assembly 56 may include a drive shaft, a differential, and/or an axle. In such non-track arrangement, the rear tractive assembly 56 includes two axles or a tandem axle arrangement. According to an exemplary embodiment, the front tractive assembly 58 is steerable (e.g., using the handlebar 42). In some embodiments, the rear tractive assembly 56 is additionally or alternatively steerable. In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first of the prime movers 52 that drives a first one of the rear tractive elements and a second of the prime movers 52 that drives a second one of the rear tractive elements when the rear tractive assembly 56 includes two rear tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include one or more rear braking components positioned to facilitate braking one or more components of the rear tractive assembly 56 (e.g., the rear axle, the rear tractive elements, etc.). In some embodiments (e.g., embodiments with two rear tractive elements), the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), suspension sensor(s), wheel/track sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the handlebar 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Rear Suspension Stop

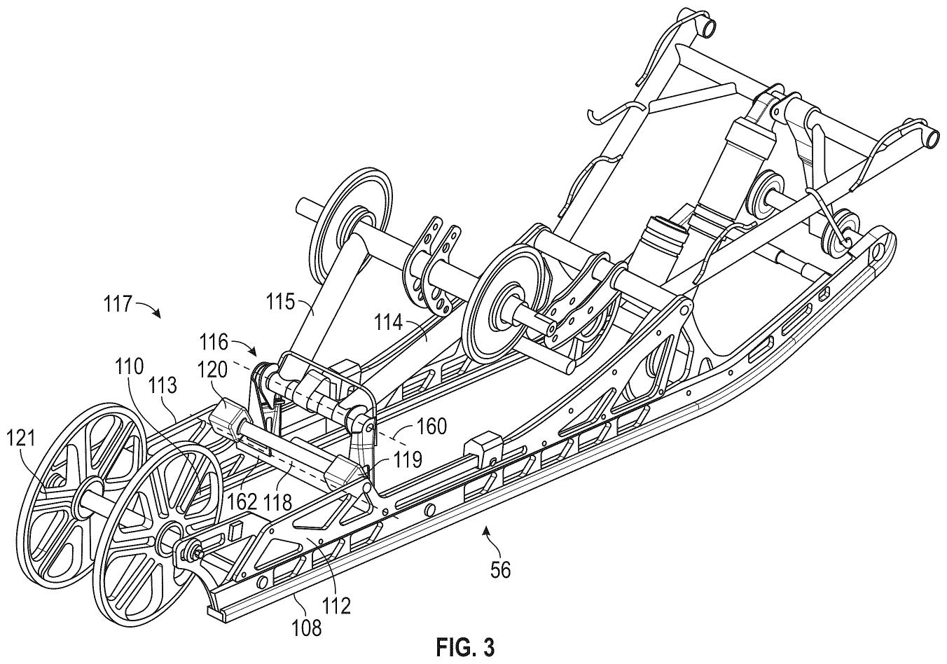

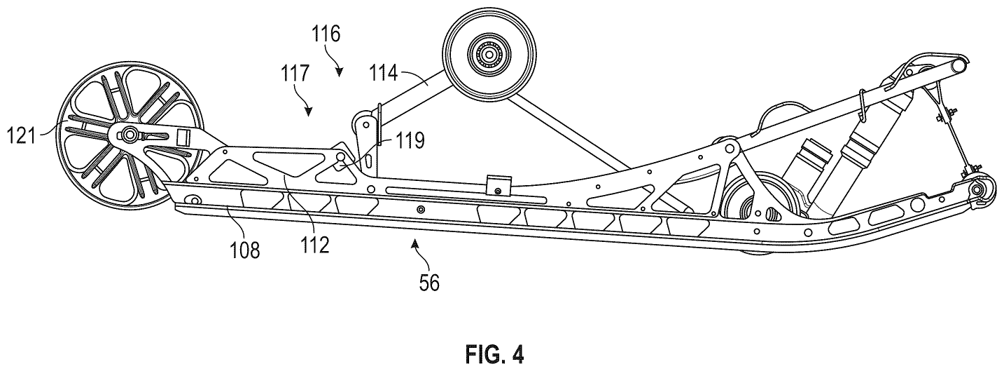

As shown in FIGS. 3-6 and 7-9, the rear tractive assembly 56 includes a first longitudinal frame element (e.g., ski, runner, slide, guide, arm, rail, etc.), shown as first trailing arm 108, a second longitudinal frame element (e.g., ski, runner, slide, guide, arm, rail, etc.), shown as second trailing arm 110, a first connection brace, shown as first connection brace 112, and a second connection brace, shown as second connection brace 113. The first trailing arm 108 is substantially parallel to the second trailing arm 110. According to an exemplary embodiment, the first trailing arm 108 and the second trailing arm 110 are configured to engage a ground surface (e.g., snow) and guide a lower portion of a track of the rear tractive assembly 56 (see, e.g., FIG. 1). As shown in FIGS. 3-6 and 7-9, the first connection brace 112 is coupled to the first trailing arm 108 along an exterior surface (e.g., a surface of the first trailing arm 108 facing towards the surrounding area of the vehicle 10) of the first trailing arm 108 and the second connection brace 113 is coupled to the second trailing arm 110 along an exterior facing surface (e.g., a surface of the second trailing arm 110 facing towards the surrounding area of the vehicle 10) of the second trailing arm 110. In some embodiments, the first connection brace 112 is coupled to the first trailing arm 108 along an interior facing surface (e.g., a surface of the first trailing arm 108 facing towards the second trailing arm 110, etc.) of the first trailing arm 108. In some embodiments, the second connection brace 113 is coupled to the second trailing arm 110 along an interior facing surface (e.g., a surface of the second trailing arm 110 facing towards the first trailing arm 108, etc.) of the first trailing arm 108.

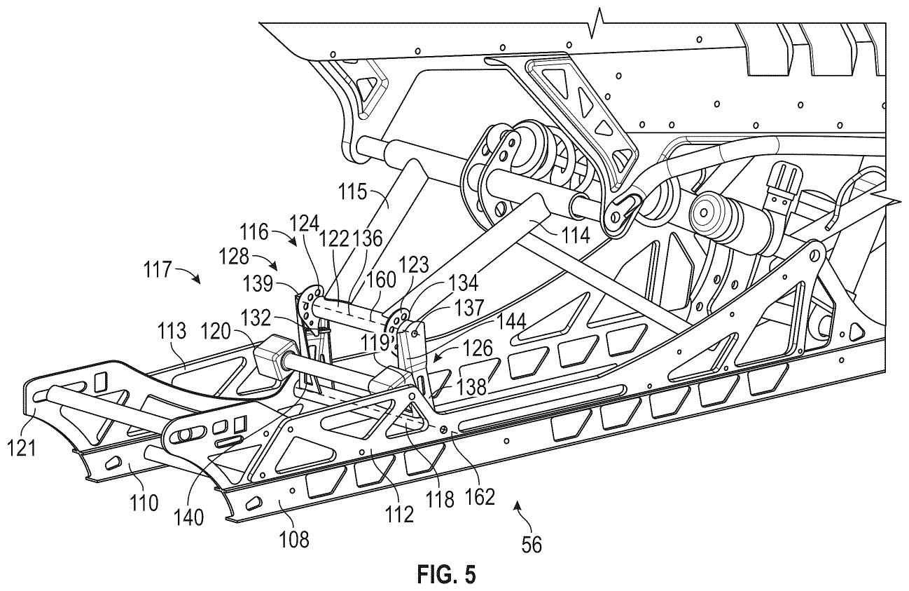

As shown in FIGS. 3-9, the rear tractive assembly 56 includes a first suspension arm, shown as first rear suspension arm 114, a second suspension arm, shown as second rear suspension arm 115, a first stop assembly, shown as rear suspension stop 116, a second stop assembly, shown as block stop 117, and a first crossmember or connector bar, shown as connecting rod 118. As shown in FIG. 5, first or upper ends of the first rear suspension arm 114 and the second rear suspension arm 115 are, and thereby the rear tractive assembly 56 is, pivotably coupled to a portion of the frame 12 of the vehicle 10 and a rear suspension component such as a coil-over suspension element (e.g., via a tubular element connected to the upper ends thereof). As shown in FIGS. 3-9, opposing second or lower ends of the first rear suspension arm 114 and the second rear suspension arm 115 are coupled to a portion of the rear suspension stop 116. According to an exemplary embodiment, the lower ends of the first rear suspension arm 114 and the second rear suspension arm 115 are angled towards each other and the upper ends of the first rear suspension arm 114 and the second rear suspension arm 115 are angled away from each other. As shown in FIGS. 3, 5, and 6, the connecting rod 118 extends between the interior surfaces of the first trailing arm 108 and the second trailing arm 110, and one or more portions (e.g., brackets) of the rear suspension stop 116 are coupled to the connecting rod 118, as described in greater detail herein.

As shown in FIGS. 3-9, the block stop 117 includes (a) a connecting member, shown as a block stop rod 154, having a first end, shown as first block stop end 119, coupled to the first connection brace 112 and an opposing second end, shown as second block stop end 120, coupled to the second connection brace 113, (b) a first stop feature (e.g., contacting piece), shown as first block 150, coupled to the block stop rod 154 and positioned proximate the first block stop end 119, and (c) a second stop feature (e.g., contacting piece), shown as second block 152, coupled to the block stop rod 154 and positioned proximate the second block stop end 120. According to an exemplary embodiment, a first distance from the block stop 117 to a rearmost portion 121 of the rear tractive assembly 56 is less than a second distance from the rear suspension stop 116 to the rearmost portion 121 of the rear tractive assembly 56. A third distance from a surface engaged by the rear tractive assembly 56 to the connecting rod 118 is less than a fourth distance from the surface engaged by the rear tractive assembly 56 to the block stop rod 154. A fifth distance from the rearmost portion 121 of the rear tractive assembly 56 to the connecting rod 118 is greater than a sixth distance from the rearmost portion 121 of the rear tractive assembly 56 to the block stop rod 154. In some embodiments the block stop 117 is coupled directly to the first trailing arm 108 and the second trailing arm 110. In such embodiments, the first connection brace 112 and the second connection brace 113 may be omitted.

As shown in FIGS. 5-9, the rear suspension stop 116 includes (a) a second

crossmember or connector bar, shown as crossmember 122, having a first end, shown as first crossmember end 134, and an opposing second end, shown as second crossmember end 136, (b) a first stop feature (e.g., projection, locking piece, retainer, etc.), shown as first cam 123, coupled to the crossmember 122 and an positioned proximate the first crossmember end 134, (c) a second stop feature (e.g., projection, locking piece, retainer, etc.), shown as second cam 124, coupled to the crossmember 122 and an positioned proximate the second crossmember end 136, (d) a first support, shown as first bracket 126, having (i) a first end, shown as upper end 137, coupled to the first crossmember end 134 of the crossmember 122 and (ii) an opposing second end, shown as lower end 138, coupled to the connecting rod 118, and (e) a second support, shown as second bracket 128, having (i) a first end, shown as upper end 139, coupled to the second crossmember end 136 of the crossmember 122 and (ii) an opposing second end, shown as lower end 140, coupled to the connecting rod 118.

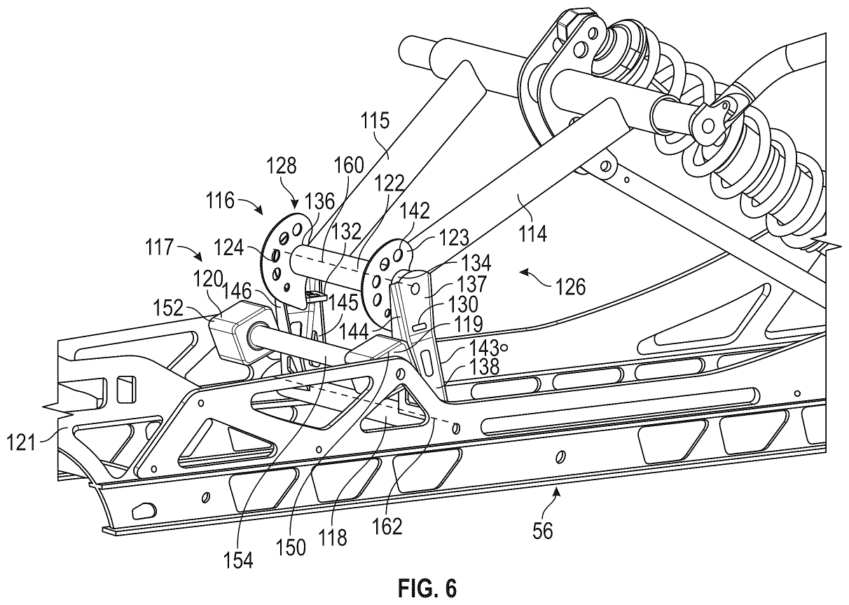

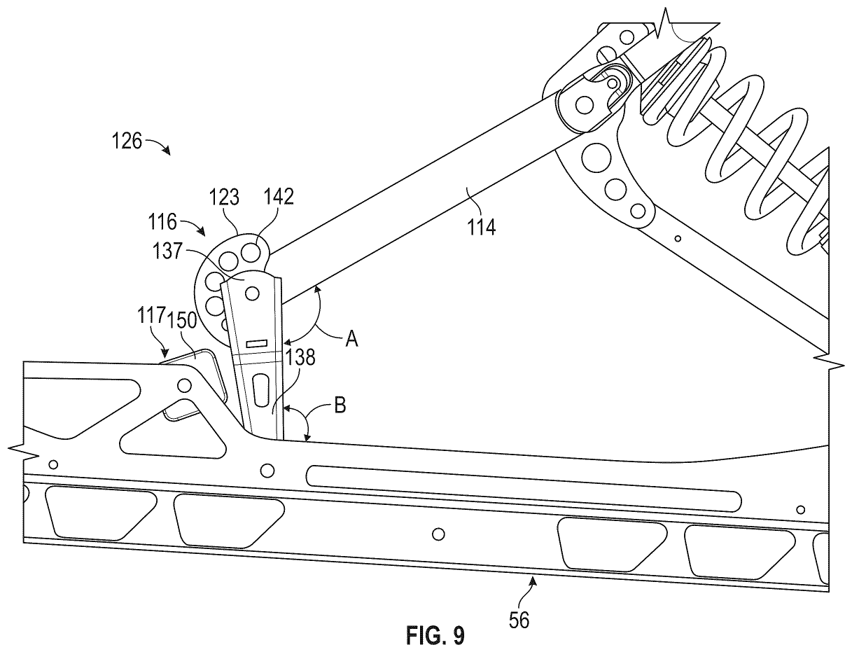

As shown in FIGS. 5-7, (a) the lower ends of first rear suspension arm 114 and the second rear suspension arm 115 are coupled to the crossmember 122 and (b) the first cam 123 and the second cam 124 are positioned between the first bracket 126 and the second bracket 128. The first rear suspension arm 114 is positioned closer to the first bracket 126 and the first cam 123 than the second bracket 128 and the second cam 124. The second rear suspension arm 115 is positioned closer to the second bracket 128 and the second cam 124 than the first bracket 126 and the first cam 123. In some embodiments, the first rear suspension arm 114 and the second rear suspension arm 115 are coupled to the crossmember 122 equidistance from the first bracket 126 and the second bracket 128. According to an exemplary embodiment, the first rear suspension arm 114, the second rear suspension arm 115, the crossmember 122, the first cam 123, and the second cam 124 are configured to pivot or rotate (a) together about a first longitudinal axis, shown as center axis 160, of the crossmember 122 and (b) relative to the upper end 137 of the first bracket 126 and the upper end 139 of the second bracket 128. In some embodiments, as shown in FIGS. 6 and 9, the first cam 123 and the second cam 124 define a series of apertures, shown as cam apertures 142, along the curved periphery thereof.

As shown in FIGS. 5 and 6, the first bracket 126 includes a first flange, shown as front flange 143, and a second flange, shown as rear flange 144, spaced from the front flange 143. The front flange 143 and the rear flange 144 extend inward and parallel to the crossmember 122. The front flange 143 and the rear flange 144 extend inward more at the lower end 138 of the first bracket 126 than at the upper end 137 of the first bracket 126. Stated another way, the front flange 143 and the rear flange 144 gradually increase in depth from the upper end 137 to the lower end 138. As shown in FIGS. 5 and 6, the second bracket 128 includes a first flange, shown as front flange 145, and a second flange, shown as rear flange 146, spaced from the front flange 145. The front flange 145 and the rear flange 146 extend inward and parallel to the crossmember 122. The front flange 145 and the rear flange 146 extends inward more at the lower end 140 of the second bracket 128 than at the upper end 139 of the second bracket 128. Stated another way, the front flange 145 and the rear flange 146 gradually increase in depth from the upper end 139 to the lower end 140. In some embodiments the depth of the flanges is consistent along the length of the first bracket 126 and/or the second bracket 128.

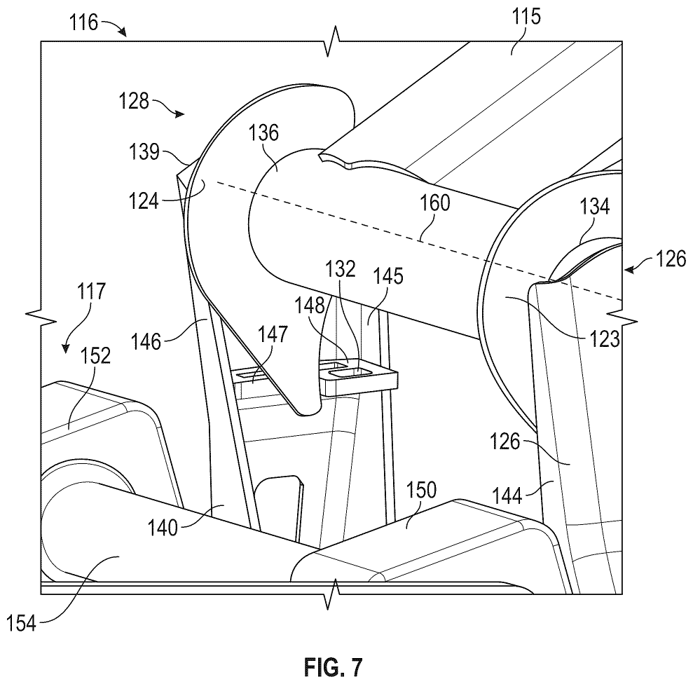

As shown in FIGS. 5-7, the rear suspension stop 116 includes (a) a first retainer, shown as first stop 130, coupled to an interior surface of the first bracket 126 between the upper end 137, the lower end 138, the front flange 143, and the rear flange 144 thereof and (b) a second retainer, shown as second stop 132, coupled to an interior surface of the second bracket 128 between the upper end 139, the lower end 140, the front flange 145, and the rear flange 146 thereof. As shown in FIG. 7, the second stop 132 (and similarly the first stop 130) includes an attachment portion, shown as base 147, and a projection portion, shown as projection 148 (shown in FIG. 7). The base 147 of the first stop 130 and the second stop 132 engages with and is received by an interface (e.g., an aperture) of the first bracket 126 and the second bracket 128, respectively. The first stop 130 and the second stop 132 span the distance between the flanges of the first bracket 126 and the second bracket 128 such that the first stop 130 and the second stop 132 act as a brace (e.g., a structural bracing member to reinforce the bracket). The projection 148 extends from the base 147, proximate the front flange 143 of the first bracket 126 and the front flange 145 of the second bracket 128 (e.g., the projections 148 extend along the inner surface of the front flange 143 and the front flange 145, such that the first stop 130 and the second stop 132 have a “L-shape,” etc.). The projections 148 are configured to selectively engage a portion or surface of first cam 123 and the second cam 124 to limit or prevent rotation of the first rear suspension arm 114, the second rear suspension arm 115, the crossmember 122, the first cam 123, and the second cam 124 are about the center axis 160 of the crossmember 122 more than a pre-configured, first maximum angle in a first rotational direction (e.g., counterclockwise). In some embodiments, the first stop 130 and the second stop 132 are integrated with the first bracket 126 and the second bracket 128 to create a singular piece. In some embodiments, the first stop 130 and the second stop 132 only engage with the front flange 143 and the front flange 145. In some embodiments, the first stop 130 and the second stop 132 are otherwise shaped, (e.g., a rectangle, a square, an I-shape, an ovular shape, etc.). In some embodiments the first stop 130 and the second stop 132 define apertures to limit the weight thereof.

According to an exemplary embodiment, the connecting rod 118 is configured to rotate and, thereby, the lower end 138 of the first bracket 126 and the lower end 140 of the second bracket 128 are configured to rotate, about a second longitudinal axis, shown as center axis 162, of the connecting rod 118. According to an exemplary embodiment, the first block 150 is configured (e.g., positioned, sized, etc.) to selectively engage with the rear flange 144 of the first bracket 126 and the second block 152 is configured (e.g., positioned, sized, etc.) to selectively engage with the rear flange 146 of the second bracket 128. The block stop 117 is configured to prevent or limit movement of the lower end 138 of the first bracket 126 and the lower end 140 of the second bracket 128 about the center axis 162 of the connecting rod 118 by more than a pre-configured, second maximum angle in an opposing second rotational direction (e.g., clockwise). Preventing further movement causes front suspension components of the vehicle 10 to also compresses. Therefore, for the first bracket 126 and the second bracket 128 to move any further, both the rear and the front suspension components of the vehicle 10 must be compressed. The second angle adjustment provides a float function that allows the first trailing arm 108 and the second trailing arm 110 to dropout in holes and terrain changes so that the rear tractive assembly 56 can maintain proper traction with the ground (e.g., snow).

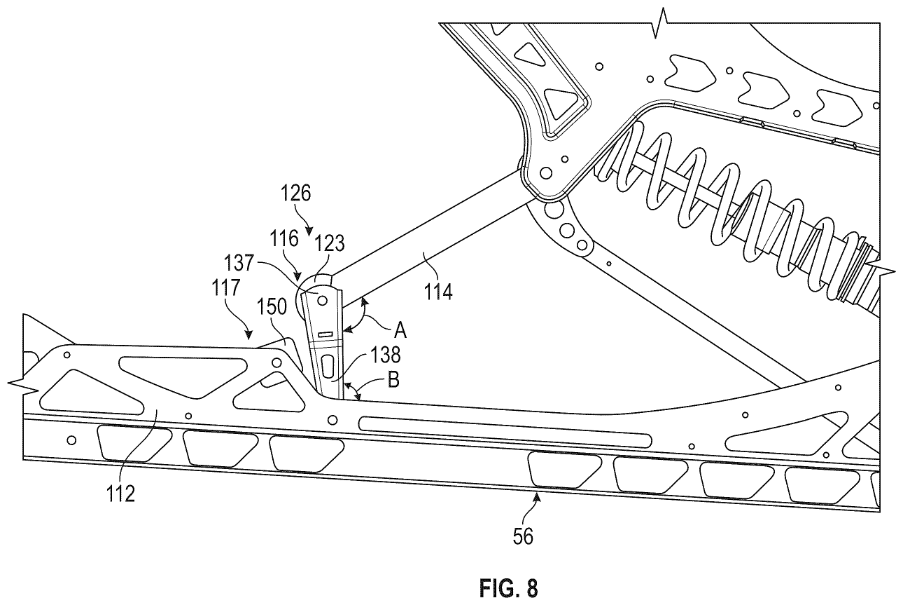

Referring now to FIGS. 8 and 9, side views of the rear suspension stop 116 and a first angle A and a second angle B are shown. The first angle A is defined between (a) the first rear suspension arm 114 and the second rear suspension arm 115 and (b) the front flange 143 and the front flange 145 of the first bracket 126 and the second bracket 128, respectively. The second angle B is defined between (a) the first trailing arm 108 and the second trailing arm 110 and (b) the front flange 143 and the front flange 145 of the first bracket 126 and the second bracket 128, respectively.

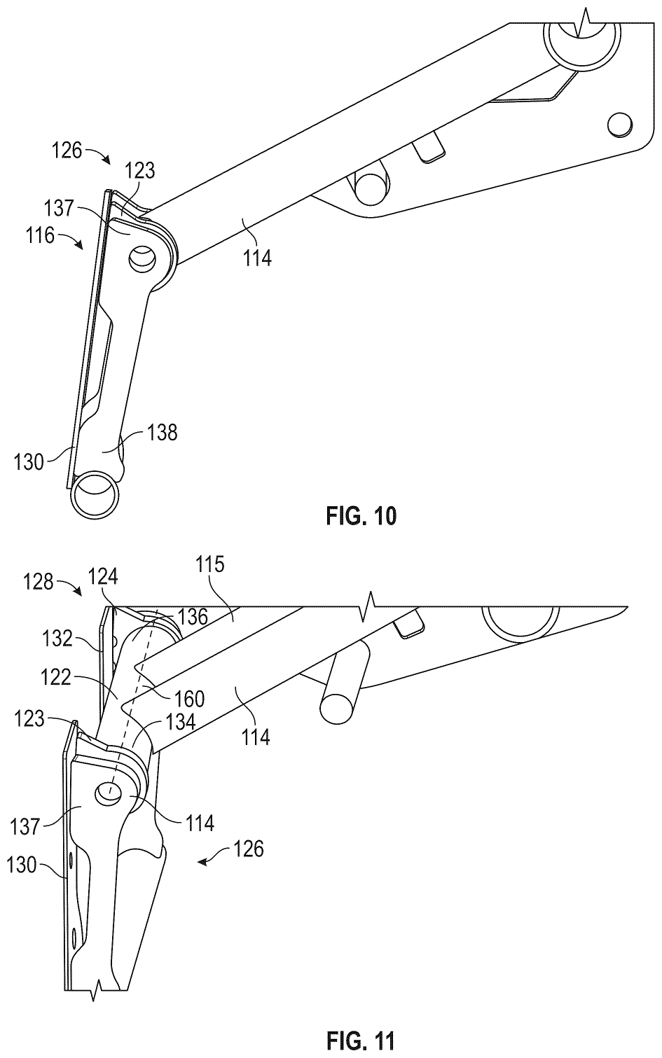

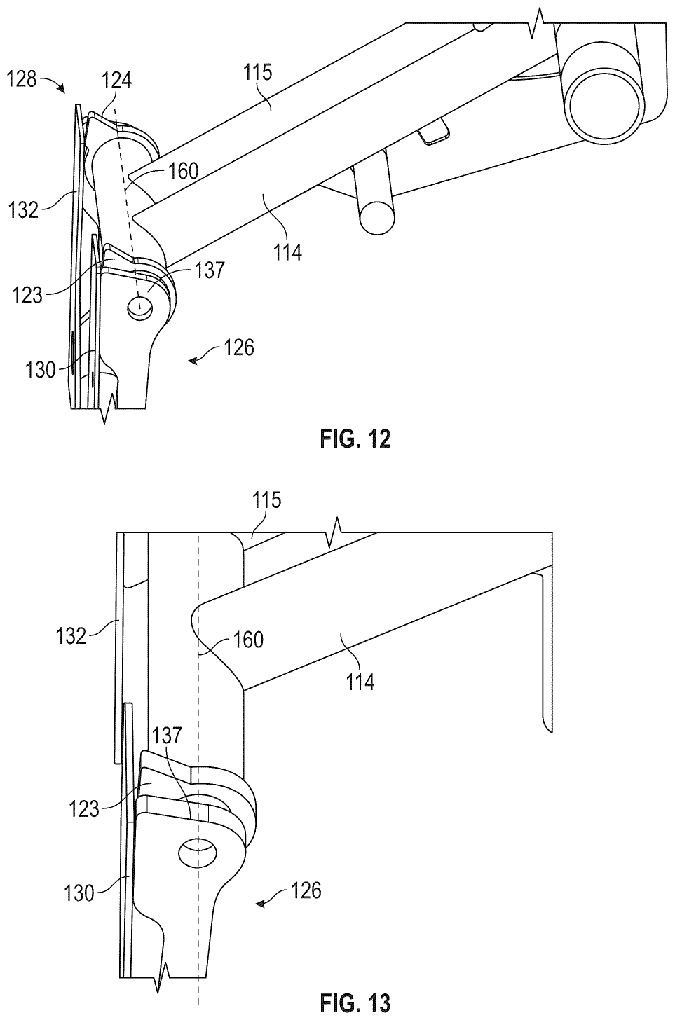

Referring now to FIGS. 10-13, an alternate embodiment of the rear suspension stop 116 is shown. The rear suspension stop 116 may be similar to the rear suspension stop 116 of FIGS. 3-9, except as otherwise described herein. The first bracket 126 and the second bracket 128 do not include the flanges. The first stop 130 is configured as a vertical plate that extend between and is coupled to the lower end 138 of the first bracket 126 and the upper end 137 of the first bracket 126. The second stop 132 is similarly configured as a vertical plate that extends between and is coupled to the lower end 140 of the second bracket 128 and the upper end 139 of the second bracket 128. The first cam 123 and the second cam 124 rotate about the center axis 160 of the crossmember 122 until the first cam 123 and the second cam 124 contact a face of the first stop 130 and the second stop 132, respectively.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.) as shown in the various exemplary embodiments is illustrative only. Additionally, any element disclosed in one embodiment may be incorporated or utilized with any other embodiment disclosed herein.

1. A snowmobile comprising:
a frame; and
a tractive assembly pivotably coupled to the frame, the tractive assembly including:
a first rail;
a second rail;
a first crossmember extending between the first rail and the second rail;
an arm having a first end and an opposing second end, the first end pivotably coupled to the frame; and
a stop assembly including:
a second crossmember coupled to the arm;
a cam coupled to the second crossmember;
a first bracket coupled to first ends of the first crossmember and the second crossmember;
a second bracket coupled to opposing second ends of the first crossmember and the second crossmember; and
one or more stops coupled to at least one of the first bracket or the second bracket, the one or more stops configured to engage a portion of the cam to selectively prevent rotation of the arm.

2. The snowmobile of claim 1, wherein the tractive assembly includes a block stop configured to engage at least one of the first bracket or the second bracket to selectively prevent rotation of the first bracket and the second bracket, the block stop extending between the first rail and the second rail.

3. The snowmobile of claim 2, wherein a first angle is defined between the arm and the first bracket and a second angle is defined between the arm and the first rail, the first angle limited by the one or more stops, the second angle limited by the block stop.

4. The snowmobile of claim 2, wherein a first distance from the first crossmember to a rearmost portion of the snowmobile is greater than a second distance from the block stop to the rearmost portion of the snowmobile.

5. The snowmobile of claim 2, wherein the block stop includes:
a block stop rod having a first end and an opposing second end, the block stop rod extending between the first rail and the second rail;
a first block positioned proximate the first end of the block stop rod and configured to engage the first bracket; and
a second block positioned proximate the second end of the block stop rod and configured to engage the second bracket.

6. The snowmobile of claim 5, wherein a first distance from a surface engaged by the tractive assembly to the first crossmember is less than a second distance from the surface engaged by the tractive assembly to the block stop rod.

7. The snowmobile of claim 1, wherein the one or more stops includes a first stop coupled to an inner surface of the first bracket and a second stop coupled to an inner surface of the second bracket.

8. The snowmobile of claim 7, wherein the cam is a first cam and the stop assembly includes a second cam coupled to the second crossmember, the second stop configured to engage the second cam, the first stop configured to engage the first cam.

9. The snowmobile of claim 8, wherein the first stop and the second stop each include:
a base coupled to a respective one of the first bracket or the second bracket; and
a projection extending from the base and configured to engage with a respective one of the first cam or the second cam.

10. The snowmobile of claim 8, wherein each of the first stop and the second stop have an L-shape.

11. The snowmobile of claim 1, wherein the first bracket includes:
a rear flange; and
a front flange, each of the rear flange and the front flange of the first bracket extending towards the second bracket and substantially parallel to the second crossmember.

12. The snowmobile of claim 11, wherein the second bracket includes:
a rear flange; and
a front flange, each of the rear flange and the front flange of the second bracket extending towards the first bracket and substantially parallel to the second crossmember.

13. The snowmobile of claim 12, wherein the one or more stops include a first stop and a second stop, the first stop coupled to the first bracket and disposed between the rear flange and the front flange of the first bracket, and the second stop coupled to the second bracket and disposed between the rear flange and the front flange of the second bracket.

14. The snowmobile of claim 12, wherein each of the first bracket and the second bracket has an upper end and a lower end, wherein the lower end is coupled to the first crossmember, the upper end is coupled to the second crossmember, and wherein each of the rear flange and the front flange increases in depth from the upper end to the lower end.

15. The snowmobile of claim 12, wherein the stop assembly includes a block stop, the block stop including:
a block stop rod extending between the first rail and the second rail;
a first block coupled to the block stop rod, the first block configured to engage the rear flange of the first bracket; and
a second block coupled to the block stop rod, the second block configured to engage the rear flange of the second bracket.

16. The snowmobile of claim 1, wherein the arm is a first arm and the tractive assembly includes a second arm having a first end and an opposing second end, the first end of the second arm pivotably coupled to the frame, the second crossmember coupled to the second arm.

17. The snowmobile of claim 16, wherein:
the cam is a first cam;
the stop assembly includes a second cam coupled to the second crossmember;
the first arm is positioned closer to the first bracket and the first cam than the second bracket and the second cam; and
the second arm is positioned closer to the second bracket and the second cam than the first bracket and the first cam.

18. The snowmobile of claim 17, wherein the one or more stops include at least one of:
a first plate extending between and coupled to a lower end of the first bracket and an upper end of the first bracket; or
a second plate extending between and coupled to a lower end of the second bracket and an upper end of the second bracket.

19. A snowmobile comprising:
a frame; and
a tractive assembly pivotably coupled to the frame, the tractive assembly including:
a first rail;
a second rail;
a first crossmember extending between the first rail and the second rail;
a first arm having a first end and an opposing second end, the first end pivotably coupled to the frame;
a second arm having a first end and an opposing second end, the first end of the second arm pivotably coupled to the frame;
a stop assembly including:
a second crossmember coupled to the first arm and the second arm;
a cam coupled to the second crossmember;
a first bracket coupled to first ends of the first crossmember and the second crossmember;
a second bracket coupled to opposing second ends of the first crossmember and the second crossmember; and
one or more stops coupled to at least one of the first bracket or the second bracket, the one or more stops configured to engage a portion of the cam to selectively prevent rotation of the first arm and the second arm; and
a block stop configured to engage at least one of the first bracket or the second bracket to selectively prevent rotation of the first bracket and the second bracket, the block stop extending between the first rail and the second rail.

20. A snowmobile comprising:
a frame; and
a tractive assembly pivotably coupled to the frame, the tractive assembly including:
a first rail;
a second rail;
a first crossmember extending between the first rail and the second rail;
an arm having a first end and an opposing second end, the first end pivotably coupled to the frame, a first angle defined between the arm and the first rail;
a stop assembly including:
a second crossmember coupled to the arm;
a cam coupled to the second crossmember;
a first bracket coupled to first ends of the first crossmember and the second crossmember, a second angle defined between the arm and the first bracket;
a second bracket coupled to opposing second ends of the first crossmember and the second crossmember; and
one or more stops coupled to at least one of the first bracket or the second bracket, the one or more stops configured to engage a portion of the cam to selectively prevent rotation of the arm, the second angle limited by the one or more stops; and
a block stop configured to engage at least one of the first bracket or the second bracket to selectively prevent rotation of the first bracket and the second bracket, the block stop extending between the first rail and the second rail, the first angle limited by the block stop;
wherein a first distance from the first crossmember to a rearmost portion of the snowmobile is greater than a second distance from the block stop to the rearmost portion of the snowmobile, and a third distance from a surface engaged by the tractive assembly to the first crossmember is less than a fourth distance from the surface engaged by the tractive assembly to the block stop.
